(19) United States
(12) Patent Application Publication
(10) Pub. No.: US 2024/0146462 A1
(43) Pub. Date: May 2, 2024

(54) RELAY-ASSISTED RETRANSMISSION

(71) Applicant: MEDIATEK INC., Hsinchu City (TW)

(72) Inventors: Guan-Yu Lin, Hsinchu City (TW); Chia-Hao Yu, Hsinchu City (TW)

(21) Appl. No.: 18/486,057

(22) Filed: Oct. 12, 2023

Related U.S. Application Data
(60) Provisional application No. 63/381,766, filed on Nov. 1, 2022.

(51) Int. Cl. H04L 1/1812; H04L 5/00; H04W 72/40

(52) U.S. Cl. CPC H04L 1/1812; H04L 5/0055; H04W 72/40

(57) ABSTRACT

Apparatus and methods are provided for relay-assisted retransmission. In one novel aspect, the remote UE receives data transmission from the source entity through a direct link and retransmission from a relay UE. In one embodiment, the relay UE receives feedback indication from the remote UE, transmits the feedback to the source entity, and retransmits one or more TBs to the remote UE through a SL connection upon detecting one or assisted retransmission triggers. In one embodiment, the feedback is a joint HARQ, wherein a NACK is sent when both the relay UE and remote UE failed, and an ACK is sent when at least one of the relay UE and the remote UE succeeds. In one embodiment, the relay UE retransmits one or more successfully received TBs to the remote UE upon receiving a failure indication from the remote UE or receiving retransmission indication from the source entity.

### CROSS REFERENCE TO RELATED APPLICATIONS

This application claims priority under 35 U.S.C. § 119 from U.S. Provisional Application No. 63/381,766 entitled “Relay-assisted ReTX,” filed on Nov. 1, 2022. The disclosure of each of the foregoing documents is incorporated herein by reference.

### TECHNICAL FIELD

The disclosed embodiments relate generally to wireless communication, and, more particularly, relay-assisted retransmission.

### BACKGROUND

Sidelink (SL) communication was introduced to enable direct transmission between two user equipments (UEs), which is also known as the device-to-device (D2D) communications. With the development of 3GPP normative works, the scenarios of sidelink are extended to UE-to-network relay, public safety, vehicle-to-everything (V2X) communications and so on. The critical role of sidelink in long term evolution (LTE) and the new radio (NR) has made it an inevitable remedy to support diverse use cases of future wireless communications.

With the SL communication, the UE can establish indirect path with the wireless network through the SL relay link. The relay link is conventionally used as an indirect path for the data transceiving. In many scenarios, the UE can also establish a direct Uu link with the wireless network. The ability of the UE to establish both direct and indirect link enables the UE with better communication adjusting to different scenarios.

Improvements and enhancements are required to use SL relay to improve UE connectivity.

### SUMMARY

Apparatus and methods are provided for relay-assisted retransmission. In one novel aspect, relay-assisted retransmission is performed when the remote UE receives data transmission from the source entity through a direct link. In one embodiment, the relay UE receives TBs of a data transmission from a source entity, wherein the data transmission is established between the source entity and a remote UE, decodes the received TBs and transmits through a SL connection with the remote UE one or more TBs upon detecting one or assisted retransmission triggers. In one embodiment, the relay UE receives feedback indication from the remote UE, wherein the feedback indication is a NACK only indication for the one or more retransmission TBs, or an ACK/NACK for each TB of the data transmission. In one embodiment, the relay UE forwards the joint ACK/NACK to the source entity indicating status of both the remote UE and the relay UE. In one embodiment, the retransmission TBs are forwarded to the remote UE in a granularity of radio link control (RLC) packet data unit (PDU). In one embodiment, the source entity is a base station in the wireless network and the data transmission is a downlink (DL) transmission. In another embodiment, the source entity is a source UE, and wherein the data transmission is a sidelink (SL) transmission.

In one novel aspect, the remote UE receives data transmission from a source entity through a direct connection with the source entity and receives retransmission of one or more TBs from a relay UE through a sidelink connection with the relay UE. In one embodiment, the one or more TBs are received in radio link control (RLC) packet data units (PDUs) from the relay UE, and wherein the remote UE performs RLC reassembling for the data packets from the source entity and from the relay UE. In one embodiment, the remote UE sends feedback indication to the relay UE, wherein the feedback indication is a NACK only indication for the one or more retransmission TBs, or an ACK/NACK for each TB of the data transmission. NACK only indication means that the remote UE sends indication to the remote UE only when it failed in DL TB decoding, while ACK/NACK means that the remote UE sends indication for each DL TB regardless of ACK or NACK. In one embodiment, the feedback indication from the remote UE is carried by a field of sidelink control information (SCI), a physical sidelink shared channel (PSSCH), or by a physical sidelink feedback channel (PSFCH).

In one novel aspect, the source entity, such as a base station or a source UE, schedules a direct transmission, such as a DL transmission or SL transmission, for a data transmission with a remote UE and a relay UE in the wireless network, configures HARQ feedback resources for HARQ transmission for feedback information of the relay UE and the remote UE, receives the feedback information of the remote UE and the relay UE, wherein the feedback information indicates reception status for one or more TBs of the data transmission, and performs relay-assisted retransmission procedure based on the feedback. In one embodiment, the HARQ feedback resource is configured using one of relay-assisted configurations comprising: HARQ resource configured for the remote UE and being used by the relay UE for the HARQ transmission, HARQ resource configured for the relay UE to report feedback information for the remote UE, and HARQ resource being dynamically configured with downlink control information (DCI). In another embodiment, the relay-assisted retransmission does not retransmit the one or more TBs if at least one of the remote UE or the relay UE succeeded. In yet another embodiment, the relay-assisted retransmission sends an indication to the relay UE to perform retransmission when the relay UE succeeded, and the remote UE failed.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that supports relay-assisted retransmission in accordance with embodiments of the current invention.

FIG. 2 illustrates an exemplary top level flow diagram for the relay-assisted retransmission in accordance with embodiments of the current invention.

FIG. 3 illustrates exemplary diagrams for difference paths for the UE-to-network and the UE-to-UE connection including relay-assisted retransmission in accordance with embodiments of the current inventions.

FIG. 4 illustrates exemplary diagrams for DL transport block (TB) monitoring and HARQ buffer maintenance for the relay-assisted retransmission in accordance with embodiments of the current inventions.

FIG. 5 illustrates exemplary diagrams for the triggering of the re-transmission through the relay path in accordance with embodiments of the current invention.

FIG. 6 illustrates exemplary diagrams for the relay UE sending HARQ feedback to the network for the relay-assisted retransmission in accordance with embodiments of the current invention.

FIG. 7 illustrates exemplary diagrams for the retransmission of the TBs through the relay path in accordance with embodiments of the current invention.

FIG. 8 illustrates exemplary diagrams for the RLC level merge of TBs for the relay-assisted retransmission in accordance with embodiments of the current inventions.

FIG. 9 illustrates an exemplary message diagram for the gNB instructed relay-assisted retransmission in accordance with embodiments of the current inventions.

FIG. 10 illustrates an exemplary flow chart for the relay UE to perform the relay-assisted retransmission in accordance with embodiments of the current inventions.

FIG. 11 illustrates an exemplary flow chart for the base station to perform the relay-assisted retransmission in accordance with embodiments of the current inventions.

FIG. 12 illustrates an exemplary flow chart for the remote UE to perform the relay-assisted retransmission in accordance with embodiments of the current inventions.

### DETAILED DESCRIPTION

Reference will now be made in detail to some embodiments of the invention, examples of which are illustrated in the accompanying drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system. Also please note that although some embodiments are described in 5G context, the invention can be applied to 6G or other radio access technology.

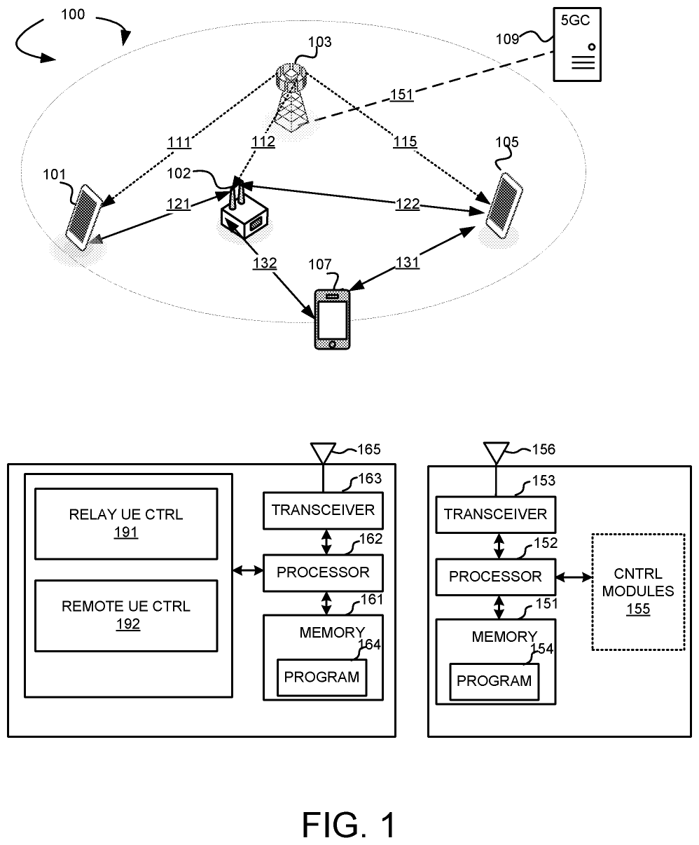

FIG. 1 is a schematic system diagram illustrating an exemplary wireless network that supports relay-assisted retransmission in accordance with embodiments of the current invention. Wireless communication network 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks. gNB 103 is a base station in the wireless network. A 5G network entity 109 connects with gNB 103 via NG connection 151. UE 101 and 102 both have Uu links with gNB 103, such as Uu link 111 and Uu link 112. UE 101 and UE 102 also established SL 121. In some scenarios, when the sidelink, such as SL 121, has limited SL throughput, UE 101 performs data transceiving with the direct Uu link, such as link 111. While in other scenarios, when there is sufficient SL throughput, the indirect path, such as SL 121 and Uu 112, are selected for the connection. In one novel aspect, when direct path, such as link 111, is selected, the relay-assisted retransmission is used to improve quality such as link robustness of the link by utilizing the SL resources. In one embodiment, the SL relay path for retransmission is used for UE-to-UE sidelink communication as well. For example, remote UE 105 has a direct sidelink connection with source UE 107. Remote UE 105 also establishes a relay path with source UE 107 through relay UE 102. The relay path includes SL link between remote UE 105 and relay UE 102 and SL 132 between relay UE 102 and source UE 107. The same applies to the relay-assisted retransmission for the UE-to-network path as well as to the UE-to-UE sidelink path. In one embodiment, the relay UE is configured with more than one relay links with more than one corresponding remote UEs for the source entity, and wherein retransmission TBs are transmitted to corresponding remote UEs based on remote UE information. For example, relay UE 102 is configured to perform relay-assisted retransmission for remote UE 101 and remote UE 105. In one embodiment, relay UE 102 sends HARQ feedback to source entity, such as gNB 103 and/or source UE 107 for multiple remote UEs, such as remote UE 101 and remote UE 105. In one embodiment, the UE information for the HARQ feedback to the source entities is explicitly carried in relay UE's HARQ feedback information to indicate whether a TB of this remote UE is successfully decoded. In another embodiment, the remote UE information is implicitly carried with relay UE's HARQ feedback information to indicate whether a TB of this remote UE is successfully decoded. For example, the resource used to transmit the HARQ feedback from the relay UE is associated with a specific remote UE.

FIG. 1 further illustrates simplified block diagrams of a base station and a mobile device/UE that supports UE-assisted report. gNB 103 has an antenna 156, which transmits and receives radio signals. An RF transceiver circuit 153, coupled with the antenna 156, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 103. Memory 151 stores program instructions and data 154 to control the operations of gNB 106. gNB 103 also includes a set of control modules 155 that carry out functional tasks to communicate with mobile stations. These control modules can be implemented by circuits, software, firmware, or a combination of them.

FIG. 1 also includes simplified block diagrams of a UE, such as UE 101. The UE has an antenna 165, which transmits and receives radio signals. An RF transceiver circuit 163, coupled with the antenna, receives RF signals from antenna 165, converts them to baseband signals, and sends them to processor 162. In one embodiment, the RF transceiver 163 may comprise two RF modules (not shown) which are used for different frequency bands transmitting and receiving. RF transceiver 163 also converts received baseband signals from processor 162, converts them to RF signals, and sends out to antenna 165. Processor 162 processes the received baseband signals and invokes different functional modules to perform features in UE 101. Memory 161 stores program instructions and data 164 to control the operations of UE 101. Antenna 165 sends uplink transmission and receives downlink transmissions to/from antenna 156 of gNB 103.

The UE also includes a set of control modules that carry out functional tasks. These control modules can be implemented by circuits, software, firmware, or a combination of them. A relay UE controller 191 receives transport blocks (TBs) of a data transmission from a source entity in the wireless network, wherein the data transmission is established between the source entity and a remote UE, decodes the received TBs of the data transmission, and transmits through a sidelink (SL) connection between the relay UE and the remote UE, one or more retransmission TBs to the remote UE upon detecting one or more assisted retransmission triggers, wherein the one or more retransmission TBs are TBs of the data transmission that are successfully decoded by the relay UE. A remote UE controller 192 establishes a sidelink (SL) connection with a relay UE, wherein the relay UE receives data packets of the data transmission from the source entity, receives the data transmission from the source entity in the wireless network, and receives data retransmission of one or more transport blocks (TBs) from the relay UE through the SL connection when the decoding of the one or more TBs failed.

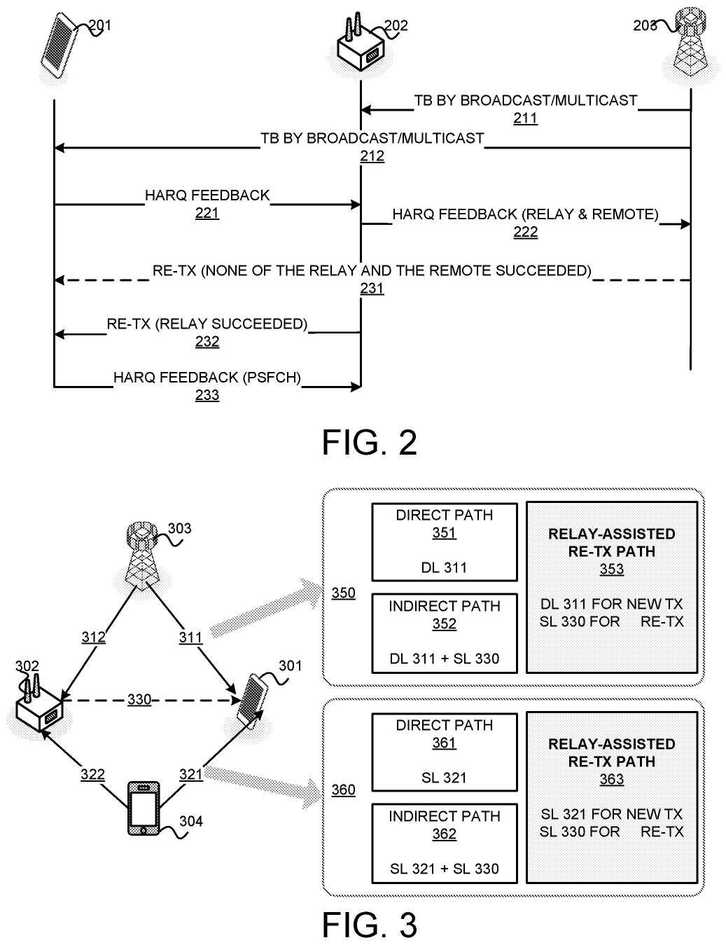

FIG. 2 illustrates an exemplary top level flow diagram for the relay-assisted retransmission in accordance with embodiments of the current invention. UE 201 established a direct Uu link with gNB 203 and a relay link through UE 202. In one novel aspect, both remote UE 201 and relay UE 202 receive the DL transmission from the network. At step 211, relay UE 202 receives DL TBs through multicast or broadcast from gNB 203. At step 212, remote UE receives DL TBs through multicast or broadcast from gNB 203. At step 221, remote UE sends HARQ feed back to the relay UE 202 indicating success or failure of the DL packets. At step 222, relay UE 202 sends to gNB 203 the HARQ feedback, which includes decoding status of both remote UE 201 and relay UE 202. In scenario, at step 231, when neither the relay UE nor the remote UE received the packet successfully, gNB 203 retransmits the failed data packets to the remote UE. When the relay UE succeeded and the remote UE failed, the relay-assisted retransmission is performed. At step 232, relay UE 202 retransmits the TBs that the remote UE failed to remote UE 201. At step 233, remote UE 201 sends HARQ feedback to relay UE 202 for the status of the retransmitted data packets. In one embodiment, the HARQ feedback at step 233 is sent through the physical sidelink feedback channel (PSFCH). In one embodiment, a similar procedure is provided when the gNB 203 is a source UE that establishes direct sidelink for data transceiving with remote UE 201 and uses the relay path through relay UE 202 for the relay-assisted retransmission.

FIG. 3 illustrates exemplary diagrams for difference paths for the UE-to-network and the UE-to-UE connection including relay-assisted retransmission in accordance with embodiments of the current inventions. In one novel aspect, a relay path with sidelink is established in the wireless to assist a direct path communication. The direct path communication is either a Uu link path with a network entity or a sidelink path with a source UE. In one novel aspect, the relay path is used for retransmission. In the first scenario 350, remote UE 301 establishes direct Uu link 311 with gNB 303. Remote UE 301 establishes sidelink connection 330 with relay UE 302, which establishes direct Uu link 312 with gNB 301. In scenario 350, remote UE 301 may communicate with gNB 303 through direct path 351, which includes the Uu link (DL) 311. Remote UE 301 may also communicate with gNB 303 through indirect link/relay link 352, which includes Uu link (DL) 312 and SL 330. In one novel aspect 353, remote UE 301 communicates with gNB 303 with direct path through Uu link (DL) 311 for new/initial transmission and uses SL 330 for retransmission. Similarly, in scenario 360, remote UE 301 establishes direct sidelink connection 321 with source UE 304. Remote UE 301 establishes sidelink connection 330 with relay UE 302, which establishes direct sidelink connection 322 with source UE 304. In scenario 360, remote UE 301 may communicate with source UE 304 through direct path 361, which includes the SL 321. Remote UE 301 may also communicate with gNB 303 through indirect link/relay link 362, which includes SL 322 and SL 330. In one novel aspect 363, remote UE 301 communicates with source UE 304 with direct path through SL 321 for new/initial transmission and uses SL 330 for retransmission. The following section of this application uses scenario 350, the UE-to-network configuration as exemplary illustrations. It is noted that the same/similar principles apply to the scenario 360, the UE-to-UE communication with relay-assisted retransmission.

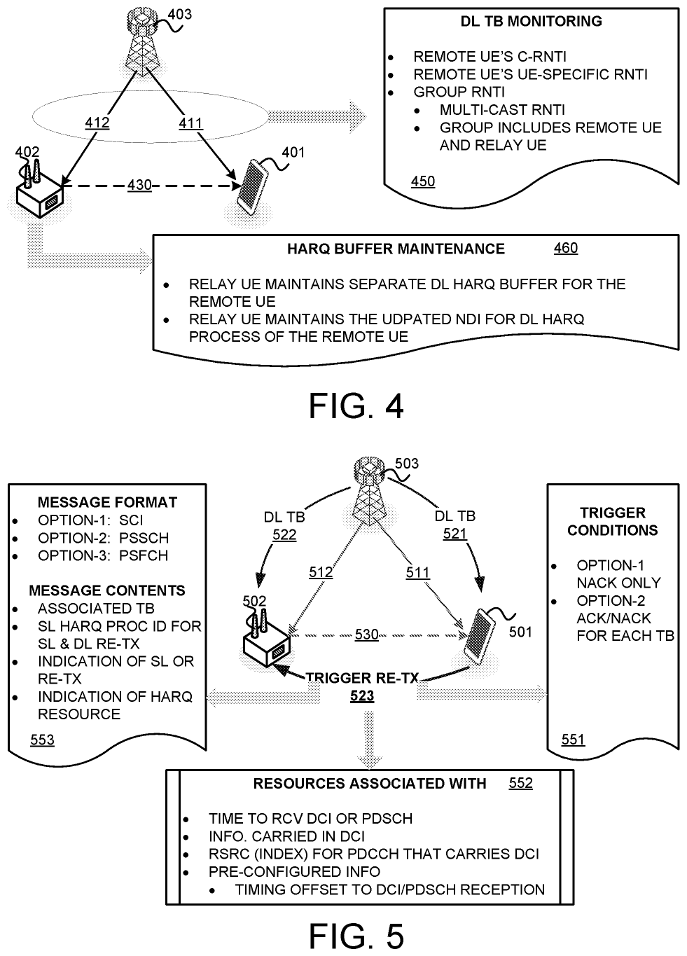

FIG. 4 illustrates exemplary diagrams for DL transport block (TB) monitoring and HARQ buffer maintenance for the relay-assisted retransmission in accordance with embodiments of the current inventions. Remote UE 401 establishes direct link 411 with gNB 403. Relay UE 402 establishes direct link 412 with gNB 403. Remote UE establishes indirect link to gNB 403 through sidelink connection 430 with relay 402 and Uu link 412. In one novel aspect, remote UE 401 receives initial/new transmission from gNB 403 through the direct path using link 411 and receives retransmission through the sidelink 430 from relay UE 402. In one embodiment, relay UE 402 overhears DL assignment (transport blocks) of remote UE 401. In one embodiment 450, radio network temporary identifier (RNTI) is used for DL TB monitoring. In embodiment, remote UE's cell RNTI (C-RNTI) is used for link 411 and 412 to identify the DL assignment/TBs for the relay-assisted retransmission. In another embodiment, remote UE's UE-specific RNTI is used to identify the DL TBs for link 411 and 412. In yet another embodiment, a group RNTI for the group including remote UE 401 and relay UE 402 are used. For example, a multicast RNTI is used for link 411 and 412. In one embodiment 460, the HARQ buffer is configured for relay UE 402 to report for HARQ status for both remote UE 401 and relay UE 402. In one embodiment, relay UE 402 maintains a separate DL HARQ buffer for remote UE 401. For example, relay UE 402 maintains the updated new data indicator (NDI) value for DL HARQ process of remote UE 401 when receiving DCI of remote UE 401 for a DL HARQ process. The NDI is the new data indicator used to indicate whether the transmitted TB using the HARQ process is for a new transmission or a retransmission. Relay UE 402 maintains NDI value for each DL HARQ process of remote UE 401, such that relay UE 402 can perform HARQ combining for new transmission and retransmission(s) of a TB using a DL HARQ process of remote UE 401 when the NDI value is unchanged. In contrast, in case relay UE 402 receives a TB of a remote UE for DL HARQ process with NDI value changed/toggled, relay UE 402 can overwrite the buffer content with the new/received TB.

FIG. 5 illustrates exemplary diagrams for the triggering of the re-transmission through the relay path in accordance with embodiments of the current invention. Remote UE 501 establishes direct link 511 with gNB 503. Relay UE 502 establishes direct link 512 with gNB 503. Remote UE establishes indirect link to gNB 503 through sidelink connection 530 with relay 502 and Uu link 512. In one novel aspect, remote UE 501 receives initial/new transmission from gNB 503 through the direct path using link 511 and receives retransmission through the sidelink 530 from relay UE 502. At step 521 and 522, remote UE 501 and relay UE 502 receive DL transmission from gNB 503, respectively. At step 523, remote UE 501, through the sidelink 530, triggers a retransmission through a retransmission indication to relay UE 402. In one embodiment 551, the triggering condition for trigger condition is NACK only, which means remote UE 501 sends the trigger indication only under a NACK condition. In another embodiment, remote UE 501 sends an ACK/NACK indication to relay UE 502 for each TB. In one embodiment 552, the resources for transmitting the trigger indication from remote UE 501 to relay UE 502 includes one or more elements comprising the timing to receive DCI or PDSCH, the information carried in DCI, the resource or resource index used for the PDCCH that carries the DCI, and preconfigured information, such as timing offset, such as timing offset of DCI/PDSCH reception. In one embodiment 553, messages format and messages contents are configured for the trigger indication for step 523. The message format is one selecting from a group of options comprising SCI field, either a new field or a new format; PSSCH; and SL feedback channel, such as the PSFCH. The message contents include one or more elements comprising: the associated TB indicated by time stamp, and/or DL HARQ process ID; indicating an SL HARQ process is used for DL retransmission, indicating separate SL HARQ process IDs for legacy SL transmission and for DL retransmission, and information for deriving resources used for HARQ Ack/NACK feedback to the network transmitted by the relay UE.

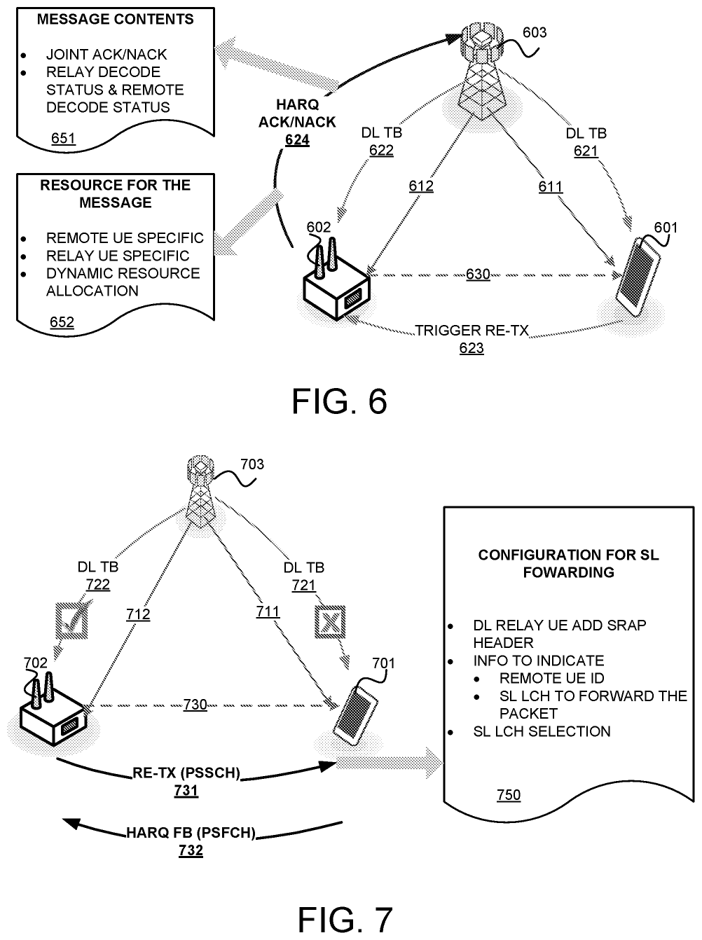

FIG. 6 illustrates exemplary diagrams for the relay UE sending HARQ feedback to the network for the relay-assisted retransmission in accordance with embodiments of the current invention. Remote UE 601 establishes direct link 611 with gNB 603. Relay UE 602 establishes direct link 612 with gNB 603. Remote UE establishes indirect link to gNB 603 through sidelink connection 630 with relay 602 and Uu link 612. In one novel aspect, remote UE 601 receives initial/new transmission from gNB 603 through the direct path using link 611 and receives retransmission through the sidelink 630 from relay UE 602. At step 621 and 622, remote UE 601 and relay UE 602 receive DL transmission from gNB 603, respectively. At step 623, a retransmission indication is received by relay UE 502. At step 624, relay UE 602 sends combined HARQ feedback to gNB 603. In one embodiment 651 the message contents of the HARQ feedback have multiple options. In one embodiment, the joint ACK/NACK is sent to gNB 603. In one embodiment, relay UE 602 sends NACK only as the joint HARQ feedback. The NACK only joint HARQ feedback is sent only when both relay UE 602 and remote UE 601 failed to receive the corresponding data packets/TBs. In another embodiment for the joint ACK/NACK feedback from relay UE 602, the ACK is sent to gNB 603 when any of the remote UE 601 or the relay UE 602 receives the corresponding data packets/TBs successfully. In another embodiment, the HARQ feedback from relay UE 602 includes both decoding status for the relay UE and the remote UE, which allows the gNB to perform outer loop link adaptation (OLLA) based on remote UE's ACK/NACK. Further, the HARQ feedback includes at least two pieces of information comprising whether the remote UE succeeded, whether the relay UE succeeded, and whether any of the remote UE and the relay UE succeeded. In one embodiment 652, different resources may be used for the HARQ feedback to the network by relay UE 602. In one embodiment, the resource is remote UE specific. The network configures HARQ feedback resource for the remote UE, and the relay UE uses it for the HARQ feedback transmission. In another embodiment, the resource is relay UE specific. The network configures for the relay UE with the resource to report HARQ feedback for one or more specific remote UE served by this relay UE for relay-assisted retransmission. In yet another embodiment, the resource is dynamically allocated. The dynamically allocated resource is used when DCI (e.g., of step 1) carries indication on the resource. The indication may indicate a subset (e.g., one) of resources from a configured resource set to be used for the HARQ feedback.

FIG. 7 illustrates exemplary diagrams for the retransmission of the TBs through the relay path in accordance with embodiments of the current invention. Remote UE 701 establishes direct link 711 with gNB 703. Relay UE 702 establishes direct link 712 with gNB 703. Remote UE establishes indirect link to gNB 703 through sidelink connection 730 with relay 702 and Uu link 712. In one novel aspect, remote UE 701 receives initial/new transmission from gNB 703 through the direct path using link 711 and receives retransmission through the sidelink 730 from relay UE 702. At step 721 and 722, remote UE 701 and relay UE 702 receive DL transmission from gNB 703, respectively. In one embodiment, a retransmission of one or more TBs is performed from relay UE 702 to remote UE 701. The retransmission is triggered by one or more triggering events including a trigger indication from remote UE 701 and trigger indication from the network entity, such as gNB 703. At step 731, relay UE 702 retransmits one or more TBs to remote UE 701. In one embodiment 750, the SL forwarding/retransmission of the one or more TBs are configured. In one embodiment, relay UE 702 adds SRAP header associated with the data for retransmission to indicate to remote UE 701 that this SL packet is exactly for DL retransmission. For indirect relay path transmission of DL data packet, the SRAP header is not included. In one embodiment, the retransmission includes one or more elements including the remote UE ID, and the SL logic channel (LCH) to forward the packet. In another embodiment, the sidelink LCH selection is based on one or more criteria comprising if a DL TB is retransmitted via SL using RLC PDU format, wherein a RLC PDU may include several RLC SDUs mapped different SL LCHs and DL MAC control elements. In one embodiment, the highest or the lowest priority LCHs and DL MAC control elements are used to determine the priority of this RLC PDU for SL transmission. At step 732, remote UE 701 sends HARQ feedback for the retransmission to relay UE 702. In one embodiment, the HARQ feedback for the retransmission is transmitted through sidelink feedback channel, such as the PSFCH.

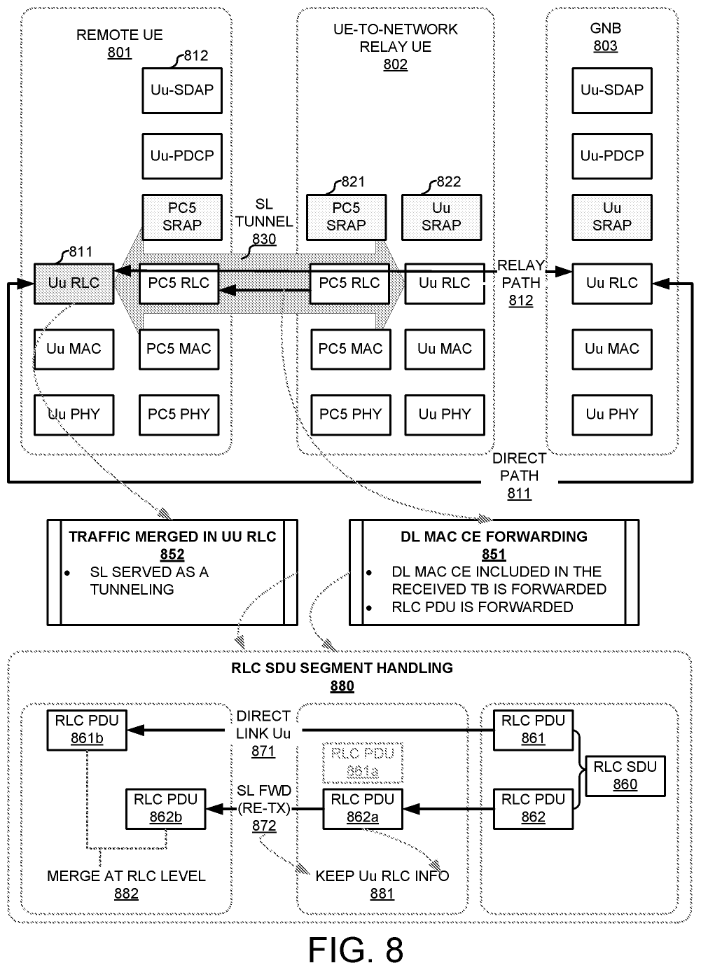

FIG. 8 illustrates exemplary diagrams for the RLC level merge of TBs for the relay-assisted retransmission in accordance with embodiments of the current inventions. Remote UE has a dual protocol stack 801 including a Uu protocol stack 811 and a sidelink/PC-5 protocol stack 812. Relay UE has a dual protocol stack 802 including a sidelink/PC-5 protocol stack 821 and a Uu protocol stack 822. gNB has a Uu protocol stack 803. In one novel aspect, remote UE established direct link 811 through Uu protocol with gNB. Remote UE established a relay path 812 through PC-5 protocol stack with gNB through relay UE. In one embodiment, SL tunnel 830 is established to forward RLC PDU, which includes Uu RLC header. In one embodiment 851, the DL MAC CE is forwarded. The DL MAC CE received in the DL TB by the relay UE is forwarded to the remote UE. The RLC PDU, instead of the SDU, is forwarded from the relay UE to the remote UE. In one embodiment 852, traffic from the direct link 811 and indirect link/relay path 812 is merged at the Uu RLC layer of the remote UE. The SL serves as a tunnel to forward RLC PDU between remote UE Uu RLC and relay UE Uu RLC. Diagram 880 illustrates an example of RLC SDU segment handling and forwarding. RLC SDU 860 is segmented to RLC PDU 861 and RLC PDU 862 for transmission through the DL to both the remote UE and the relay UE. As an example, RLC PDU 861 is received successfully through the direct link/Uu link 871 by the remote UE (RLC PDU 861b). The remote UE failed to receive RLC PDU 862 through the direct link. The relay UE received PDU 862 successfully (RLC PDU 862a). At step 881, relay UE keeps Uu RLC information of RLC PDU 862a and forwards it to the remote UE. The Uu RLC information includes one or more elements for RLC reassembling and ordering such as but not limited to sequence number (SN), SI and SO field. In one embodiment, the remote UE receives the retransmission of RLC PDU 862a from through the SL forwarding/retransmission 872 and successfully received (RLC PDU 862b). In one embodiment, remote UE received RLC PDU 861b and RLC PDU 862b from different paths, which are the direct path 871 and relay path 872, respectively. At step 882, remote UE reassembles the segmented RLC PDUs received from different sources at the Uu RLC layer.

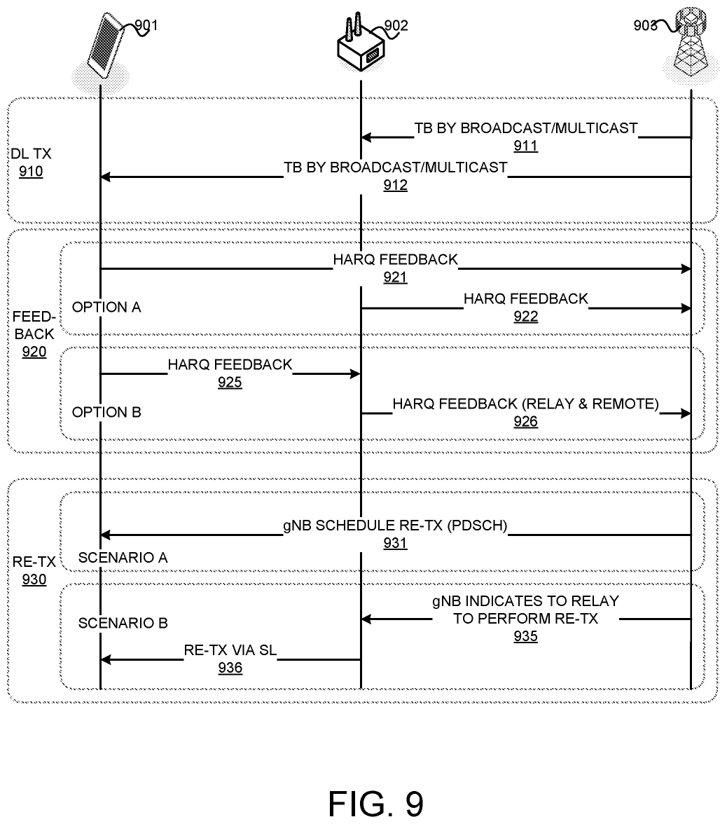

FIG. 9 illustrates an exemplary message diagram for the gNB instructed relay-assisted retransmission in accordance with embodiments of the current inventions. In one embodiment, the relay-assisted retransmission is initiated/instructed by the network entity, such as the gNB. Remote UE 901 establishes direct link with gNB 903 and a relay path through relay UE 902 with sidelink with the relay UE. At procedure 910, remote UE 901 and relay UE 902 receive downlink transmission from gNB 903. gNB 903 transmits DL TBs through broadcast or multicast to relay UE 902 (at step 911) and remote UE 902 (at step 912). At procedure 920, gNB 903 receives feedback from remote UE 901 and relay UE 902. In the first option A, remote UE 901 and relay UE 902 send HARQ feedback to gNB 903 independently at steps 921 and 922, respectively. In the second option B, remote UE 901 sends HARQ feedback to relay 902 at step 925. At step 926, relay UE 902 sends HARQ feedback to gNB 903 indicating status of both relay UE and remote UE. In one embodiment, upon receiving the HARQ feedback indicating status of the remote UE and the relay UE, gNB 903 performs/instructs retransmission for the failed TBs. At step 931, for scenario A when both the relay UE and the remote UE failed, gNB 903 scheduled retransmission to the remote UE for the failed TBs. In scenario B, when relay UE 902 receives the packets/TBs successfully and the remote UE failed, at step 935, gNB 902 sends message indicating to relay UE 902 to perform retransmission for the failed TBs to remote UE 901. At step 936, relay UE 902, upon receiving the instructions from gNB 903, retransmits the corresponding TBs to remote UE 901 through the sidelink.

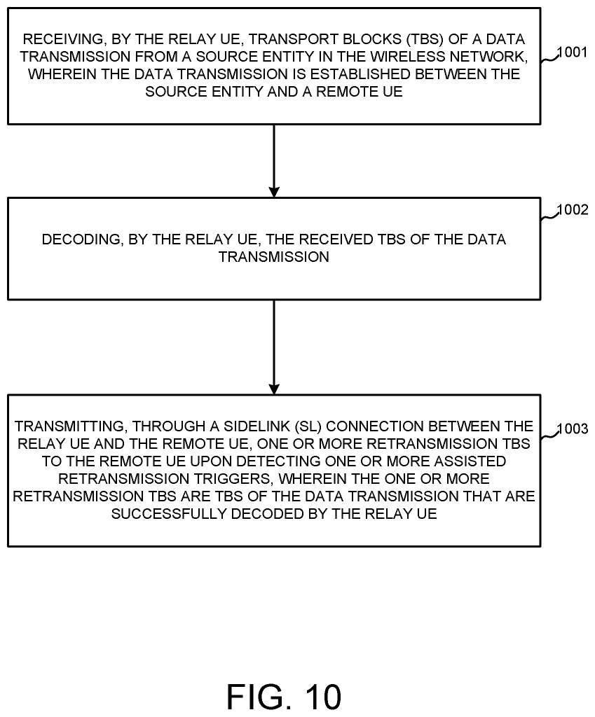

FIG. 10 illustrates an exemplary flow chart for the relay UE to perform the relay-assisted retransmission in accordance with embodiments of the current inventions. At step 1001, the relay UE receives transport blocks (TBs) of a data transmission from a source entity in the wireless network, wherein the data transmission is established between the source entity and a remote UE. At step 1002, the relay UE decodes the received TBs of the data transmission. At step 1003, the relay UE transmits through a sidelink (SL) connection between the relay UE and the remote UE, one or more retransmission TBs to the remote UE upon detecting one or more assisted retransmission triggers, wherein the one or more retransmission TBs are TBs of the data transmission that are successfully decoded by the relay UE.

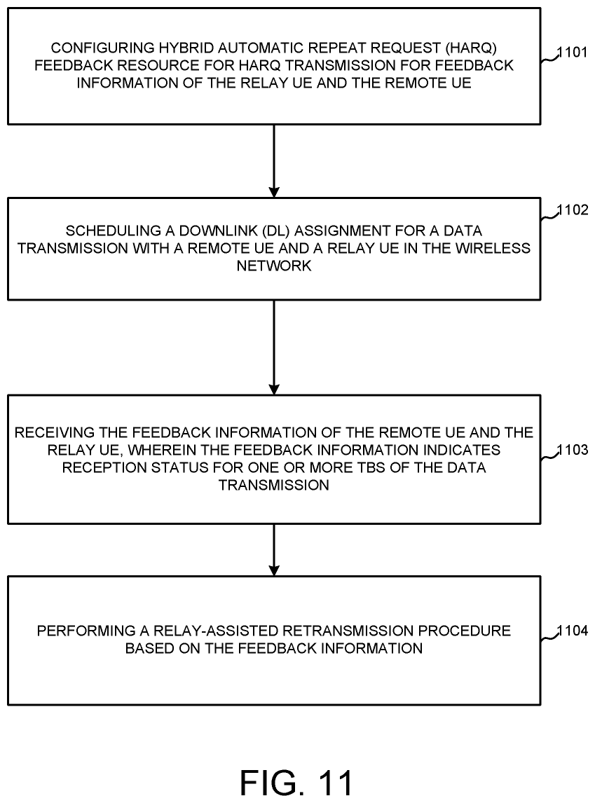

FIG. 11 illustrates an exemplary flow chart for the base station to perform the relay-assisted retransmission in accordance with embodiments of the current inventions. At step 1101, the base station configures hybrid automatic repeat request (HARQ) feedback resource for HARQ transmission for feedback information of the relay UE and the remote UE. At step 1102, the base station schedules a downlink (DL) assignment for a data transmission with a remote UE and a relay UE in the wireless network. Alternatively, the resource for HARQ feedback transmission may be pre-configured and be derived according to the transmission resource or the content of DCI signaled by based station at step 1101 for DL assignment. At step 1103, the base station receives the feedback information of the remote UE and the relay UE, wherein the feedback information indicates reception status for one or more TBs of the data transmission. At step 1104, the base station performs a relay-assisted retransmission procedure based on the feedback information.

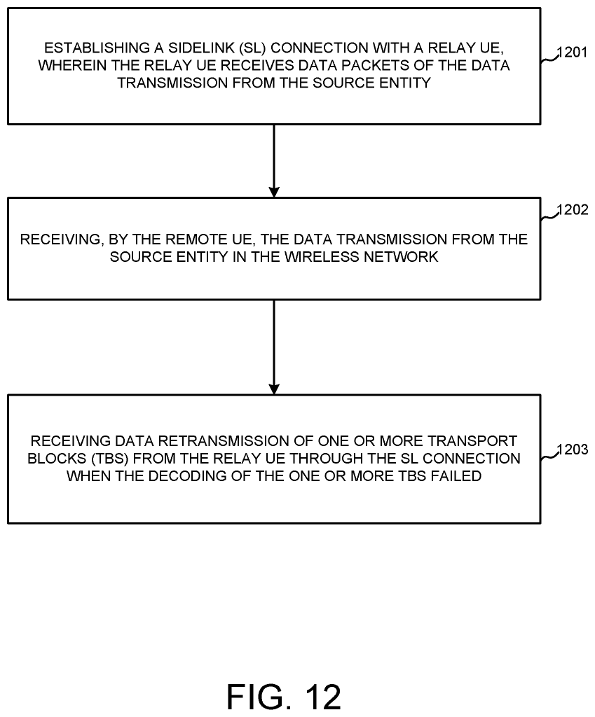

FIG. 12 illustrates an exemplary flow chart for the remote UE to perform the relay-assisted retransmission in accordance with embodiments of the current inventions. At step 1201, the remote UE establishes a sidelink (SL) connection with a relay UE, wherein the relay UE receives data packets of the data transmission from the source entity. At step 1202, the remote UE receives the data transmission from the source entity in the wireless network. At step 1203, the remote UE receives data retransmission of one or more transport blocks (TBs) from the relay UE through the SL connection when the decoding of the one or more TBs failed.

Note that in this invention, we apply SL interface, as the interface for direct UE-to-UE communication specified by 3GPP, for relay UE to perform retransmission of remote UE's DL TB. However, the invention is not limited thereto. The radio interface for retransmission of remote UE's DL TB can apply different radio interfaces or different radio access technologies as the tunnel to forward packet from the relay UE to the remote UE. For example, the DL TB for retransmission can be forwarded from relay UE to its serving remote UE via WiFi, blue-tooth, UWB technology, or other UE-to-UE communication techniques.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a relay user equipment (UE) in a wireless network comprising:
receiving, by the relay UE, transport blocks (TBs) of a data transmission from a source entity in the wireless network, wherein the data transmission is established between the source entity and a remote UE;
decoding, by the relay UE, the received TBs of the data transmission; and
transmitting, through a sidelink (SL) connection between the relay UE and the remote UE, one or more retransmission TBs to the remote UE upon detecting one or more assisted retransmission triggers, wherein the one or more retransmission TBs are TBs of the data transmission that are successfully decoded by the relay UE.

2. The method of claim 1, further comprising receiving a feedback indication from the remote UE, and wherein the feedback indication is a NACK only indication for the one or more retransmission TBs, or an ACK/NACK for each TB of the data transmission.

3. The method of claim 2, wherein the assisted retransmission trigger is the feedback indication indicates a failure in decoding the one or more retransmission TBs.

4. The method of claim 2, wherein the feedback indication from the remote UE is carried by a field of sidelink control information (SCI), a physical sidelink shared channel (PSSCH), or by a physical sidelink feedback channel (PSFCH).

5. The method of claim 2, wherein the feedback indication includes one or more elements comprising one or more time stamps to identify associated time slots for the one or more retransmission TBs, an SL HARQ process being used for the transmission of the retransmission TBs, a separate SL HARQ for the retransmission TBs, and information for deriving resources for the relay UE to send feedback to the source entity.

6. The method of claim 2, further comprising sending a joint HARQ to the source entity based on the feedback indication from the remote UE, wherein a NACK is sent when both the relay UE and remote UE failed, and an ACK is sent when at least one of the relay UE and the remote UE succeeds.

7. The method of claim 2, further comprising sending a relay UE decoding status and a remote UE decoding status to the source entity based on the feedback indication.

8. The method of claim 1, wherein the assisted retransmission trigger is receiving a retransmission indication from the source entity indicating to retransmit the one or more retransmission TBs to the remote UE.

9. The method of claim 1, wherein the retransmission TBs are forwarded to the remote UE in a granularity of radio link control (RLC) packet data unit (PDU).

10. The method of claim 1, wherein the relay UE is configured with more than one relay links with more than one corresponding remote UEs for the source entity, and wherein retransmission TBs are transmitted to corresponding remote UEs based on remote UE information.

11. The method of claim 10, further comprising sending corresponding remote UE HARQ feedback to the source entity, and wherein remote UE information is explicitly or implicitly carried in relay UE's HARQ feedback information.

12. The method of claim 1, wherein the source entity is a base station in the wireless network and the data transmission is a downlink (DL) transmission.

13. The method of claim 1, wherein the source entity is a source UE, and wherein the data transmission is a sidelink (SL) transmission.

14. A method for a remote user equipment (UE) with a data transmission connection with a source entity in a wireless network comprising:
establishing a sidelink (SL) connection with a relay UE, wherein the relay UE receives data packets of the data transmission from the source entity;
receiving, by the remote UE, the data transmission from the source entity in the wireless network;
receiving data retransmission of one or more transport blocks (TBs) from the relay UE through the SL connection when the decoding of the one or more TBs failed.

15. The method of claim 14, wherein the one or more TBs are received in radio link control (RLC) packet data units (PDUs) from the relay UE, and wherein the remote UE performs RLC reassembling at the RLC layer for the data packets from the source entity and from the relay UE.

16. The method of claim 14, further comprising sending feedback indication to the relay UE, wherein the feedback indication is a NACK only indication for the one or more retransmission TBs, or an ACK/NACK for each TB of the data transmission.

17. A method for a base station in a wireless network comprising:
configuring hybrid automatic repeat request (HARQ) feedback resource for HARQ transmission for feedback information of the relay UE and the remote UE;
scheduling a downlink (DL) assignment for a data transmission with a remote UE and a relay UE in the wireless network;
receiving the feedback information of the remote UE and the relay UE, wherein the feedback information indicates reception status for one or more TBs of the data transmission; and
performing a relay-assisted retransmission procedure based on the feedback information.

18. The method of claim 17, wherein the HARQ feedback resource is configured using one of relay-assisted configurations comprising: HARQ resource configured for the remote UE and being used by the relay UE for the HARQ transmission, HARQ resource configured for the relay UE to report feedback information for the served remote UE(s), and HARQ resource being dynamically configured with downlink control information (DCI).

19. The method of claim 17, wherein a base station does not retransmit the one or more TBs if at least one of the remote UE or the relay UE succeeded.

20. The method of claim 17, wherein a base station sends indication to the relay UE to perform retransmission when the relay UE succeeded and the remote UE failed in DL TB reception.
